(19) United States
(12) Patent Application Publication
(10) Pub. No.: US 2023/0278611 A1
(43) Pub. Date: Sep. 7, 2023

(54) Collapsible Utility Cart

(71) Applicants: Jeffrey Schepp, Fort Myers, FL (US); Michael Marino, Key West, FL (US)

(72) Inventors: Jeffrey Schepp, Fort Myers, FL (US); Michael Marino, Key West, FL (US)

(21) Appl. No.: 17/684,886

(22) Filed: Mar. 2, 2022

(51) Int. Cl. B62B 1/20; B62B 1/26

(52) U.S. Cl. CPC B62B 1/208; B62B 1/266

(57) ABSTRACT

A collapsible utility cart includes an elongate frame having upper and lower ends. A handle is formed proximate the upper end of the frame. A pair of wheels are axially rotatably connected to the frame and are pivotable between an open condition wherein the wheels are axially aligned with one another and a folded condition wherein the wheels are axially parallel to one another. Upper and lower support element are interconnected pivotally to the frame and are alternatable between collapsed conditions folded against the frame and open conditions extending forwardly from the frame. A plurality of clips are carried by the upper support element for securing a collection bag to the upper support element.

### FIELD OF THE INVENTION

This invention relates to a collapsible utility card and, more particularly, to a wheeled cart for collecting, supporting and transporting yard waste and other items. The wheels and other structural components of the cart are conveniently foldable to facilitate compact storage of the cart when it is not in use. The cart's components are also readily adjusted to alternate the cart between various operating positions.

### BACKGROUND OF THE INVENTION

Conventional utility carts are currently available to assist in collecting and hauling yard waste such as fallen leaves, shrubbery trimmings and grass clippings. See for example, Harling, U.S. Pat. No. 5,380,033 and Levy et al., US Publication No. 2002/0084629. Although such products can be wheeled across most normal yard surfaces and feature some degree of collapsibility, they also exhibit a number of shortcomings. Conventional utility carts are not especially versatile and tend to employ an unduly complicated and less than ergonomic construction. For example, Hailing supports a bucket or bag in a perfectly upright condition that complicates lifting and loading leaves, grass clippings and other yard waste into the supported container. The Harling cart also folds in an awkward and somewhat bulky manner. As a result, transport and storage of the cart are not very convenient. Removing the collected waste from the Hailing cart is similarly problematic because the waste container must be tediously disengaged from the upper support ring of that product in order to lift the filled container off of a cart. The positioning of Harling's upper support ring is not readily adjustable and removing the container can therefore be extremely unwieldy and inconvenient, especially when the waste-filled container is heavy.

None of the utility carts that are currently available exhibit optimal collapsibility and versatility. In virtually all of these devices, the waste container can be supported in only a single set operational position. Such carts cannot be readily adjusted to accommodate and haul not only yard waste receptacles but an assortment of other bulky items such as boxes, brick pavers and bags of fertilizer, mulch and soil. A much more versatile, ergonomic and conveniently foldable utility cart is needed, especially to facilitate cleanup and maintenance tasks requiring the collection and hauling of yard waste, landscape supplies and the like.

### SUMMARY OF THE INVENTION

It is therefore an object of the present invention to provide a conveniently collapsible and positionally adjustable utility cart for facilitating the collection and transport of yard waste and various other items.

It is a further object of this invention to provide a collapsible utility cart featuring an improved ergonomic design and which is more versatile than existing utility carts.

It is a further object of this invention to provide a collapsible utility cart that may be readily adjusted between multiple operating modes or positions to facilitate the cleanup; hauling away and disposal of yard waste and other types of refuse.

It is a further object of this invention to provide a utility cart that is more conveniently and compactly collapsible than conventional carts.

It is a further object of this invention to provide a collapsible utility cart which securely retains a bag for collecting waste materials and which allows the bag to be quickly and easily detached and removed from the cart when filled.

It is a further object of this invention to provide a collapsible utility cart that supports a waste-collecting bag at an ergonomically beneficial height and orientation to facilitate the loading of refuse into the supported bag.

It is a further object of this invention to provide a utility cart that may be collapsed into an extremely compact condition to facilitate transport and storage of the cart when it is not in use.

This invention features a collapsible utility cart including an elongate frame having upper and lower ends. A handle is formed proximate the upper end of the frame. A pair of wheels are axially rotatably connected to the frame proximate the lower end. Each wheel includes a hub that is pivotally interconnected to the frame such that the wheels are selectively alternatable between an open condition, wherein the wheels are substantially axially aligned with one another, and a folded condition, wherein the wheels are substantially axially parallel to one another. A lower support element is interconnected pivotally to the frame proximate the lower end of the frame. An upper support element is interconnected pivotally to the frame proximate the upper end of the frame. The lower support element is pivotally alternatable between a collapsed condition folded generally flat against the frame and an open condition extending forwardly from the frame. The upper support element is pivotally alternatable between a collapsed condition generally flat against the frame and an open condition extending forwardly of the frame. The upper support element carries one or more clips. Each clip selectively attaches to a collection bag to hold the collection bag open and secure the bag to the upper support element. The frame carries a supportive leg for engaging the ground or other underlying surface when the frame is tilted rearwardly about the wheels in an open condition. This supports the cart with the frame at an angle to the underlying surface, which facilitates the introduction of waste material into a collection bag secured between the upper and lower support elements in their respective open conditions.

In a preferred embodiment, the frame may include a spaced apart, substantially parallel pair of tubular vertical frame components that are interconnected at respective upper ends by a horizontal tubular component defining the handle. The hub of each wheel may be connected to a respective wheel mounting bracket. Each wheel mounting bracket is, in turn, hingedly joined to a respective vertical frame component. This permits the wheels to be selectively opened and collapsed relative to the frame.

The lower support element preferably includes a platform that is pivotally mounted between a pair of lower support mounting brackets that are, in turn, connected to respective vertical frame components proximate lower ends thereof. The platform may also be interconnected to the frame by a pair of lockable folding hinge elements. Each lockable folding hinge element interconnects one side of the lower support element with an intermediate segment of a respective vertical frame component between the upper and lower ends of the frame. A platform support stand may be attached to a bottom of the platform for engaging the ground or other underlying surface when the platform is opened. The platform support stand is preferably foldably connected to the platform such that the support stand may be folded closed against the bottom of the platform when the platform is in a closed condition.

The upper support element may include a mounting ring that is pivotally attached by a pair of upper hinges to respective vertical frame components proximate an upper end of the frame. The bag attachment clips are attached to and spaced about the mounting ring. Each clip is alternatable between an open condition for receiving an edge of a bag to be supported on the cart and a closed condition for securing the bag to the upper support ring.

The support leg is preferably pivotally connected to a portion of the frame extending between the vertical frame components and alternatable between a closed condition against the frame and an open condition, wherein the support leg extends at a positive angle relative to the elongate frame. When the support leg and the wheels are opened, the frame may be tilted relative to the wheels such that a lower end of the support leg engages an underlying surface to hold the cart with the frame in the tilted condition. When the upper and lower support elements are opened and a bag is attached to the upper support element, the bag is held at an angle that is convenient for introducing waste into the bag through the ring.

Each wheel mounting bracket may be hingedly interengaged with a respective lower support mounting bracket. The wheel mounting bracket may include a bushing having a vertical channel formed therethrough. The respective interengaged lower support mounting bracket may include a slot that receives the bushing and a pair of vertically aligned holes that align with the channel of the bushing received in the slot. The aligned holes and bushing accommodate a respective vertical frame component such that the wheel mounting bracket is hingedly interengaged with the respective lower support mounting component and foldably joined to a respective vertical frame component.

The upper ring may be pivoted upwardly beyond the open condition such that the upper ring extends at an angle greater than 90 degrees to the frame. This permits a filled bag that has been attached to the clips to be disengaged from the clips and conveniently removed from the cart without interference from the upper support ring.

### BRIEF DESCRIPTION OF THE DRAWINGS

Other objects, features and advantages will occur from the following description of a preferred embodiment and the accompanying drawing, in which:

FIG. 1 is a front perspective view of the collapsible utility cart in accordance with this invention; a refuse collection bag operably attached to the cart is disclosed in phantom and the cart is depicted in an upright bag-loading mode;

FIG. 2 is a rear perspective view of the cart in a lowered loading mode with the frame tilted and supported at an angle by the support leg; this position facilitates the loading of refuse into the attached bag;

FIG. 3 is an elevational side view of the cart in a bag removal mode with the upper support ring pivoted upwardly to facilitate removal of a filled bag from the cart;

FIG. 4 is a fragmentary side view of a lower end of the cart depicting how the platform and wheels are foldably interconnected to the frame and particularly showing the platform in a closed condition and one of the wheels (in phantom) in an open condition;

FIGS. 5 and 6 are perspective views of a representative bag attachment clip used in the cart;

FIG. 7 is an elevational side view of the cart with the upper mounting ring and lower platform in closed conditions and the wheels in an open condition; and

FIG. 8 is a cross sectional view taken through line 8-8 of FIG. 7 of the cart in a fully collapsed condition for storage and which facilitates movement of the cart along an underlying surface in a compact and convenient manner.

### DETAILED DESCRIPTION OF PREFERRED EMBODIMENTS

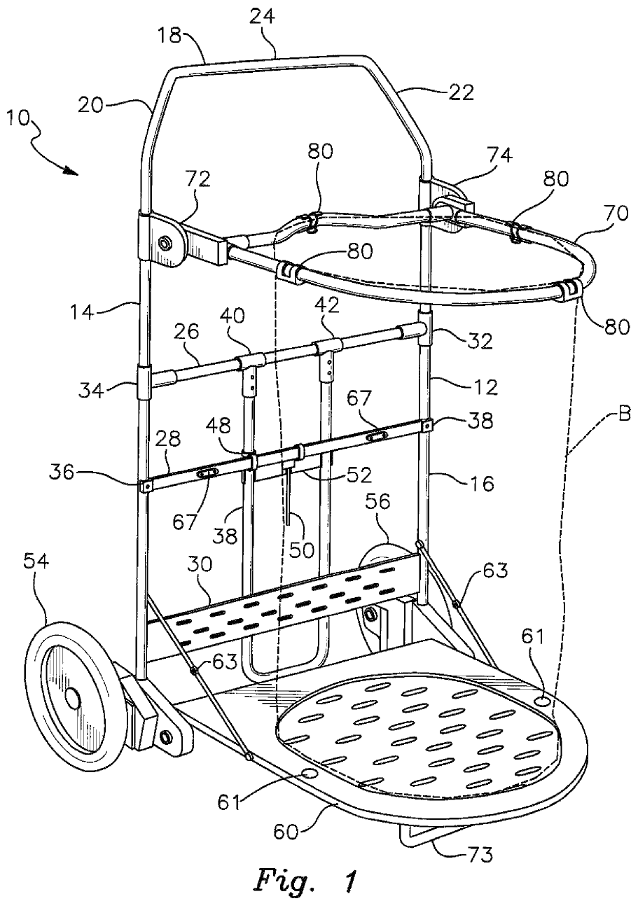

There is shown in FIGS. 1-3 a utility cart 10 that is particularly effective for collecting, supporting, transporting and disposing of yard waste. Cart 10 may also be conveniently used to move other items such as gardening and landscape supplies across an underlying surface, which may comprise all types of indoor and outdoor surfaces. Although cart 10 is especially advantageous when used to collect bagged grass clippings, leaves and other types of yard waste, the particular applications for which the cart may be employed are not a limitation of this invention.

Cart 10 includes an elongate frame 12 which preferably comprises a durable, yet relatively lightweight metal or metal alloy. A largely tubular aluminum frame is especially preferred. Frame 12 includes a spaced apart and substantially parallel pair of generally vertical tubular frame components 14 and 16, which are interconnected at respective upper ends by a tubular handle 18 that is unitarily connected to the elongate frame components. More particularly, handle 18 includes a pair of angular segments 20 and 22 that are inclined rearwardly from the elongate frame components and which themselves are joined by a generally horizontal segment 24. In particular, handle 18 is tilted rearwardly from the elongate vertical frame components to improve the handling and ergonomic operation of cart 10.

Vertical frame components 14 and 16 are laterally interconnected by an upper tube 26, an intermediate bar 28 and a lower bracket 30. Tube 26 is attached at one end to frame component 14 by a tubular T-connector 34. The opposite end of tube 26 is joined to vertical component 16 by an analogous T-connector 32. The T-connectors themselves may be secured in place along vertical components 14 and 16 by screws, rivets or other known types of fasteners. Intermediate bar 28 is typically composed of a metal or metal alloy and is secured to respective vertical components 14 and 16 by fastening brackets 36 and 38 that are again joined to the vertical frame components by appropriate fasteners. Likewise, bracket 30 is attached proximate the lower ends of frame components 14 and 16. In particular, each end of bracket 30 is curved to generally conformably engage a respective tubular component 14, 16. Again, appropriate fasteners are employed to securely connect the bracket to the vertical frame components.

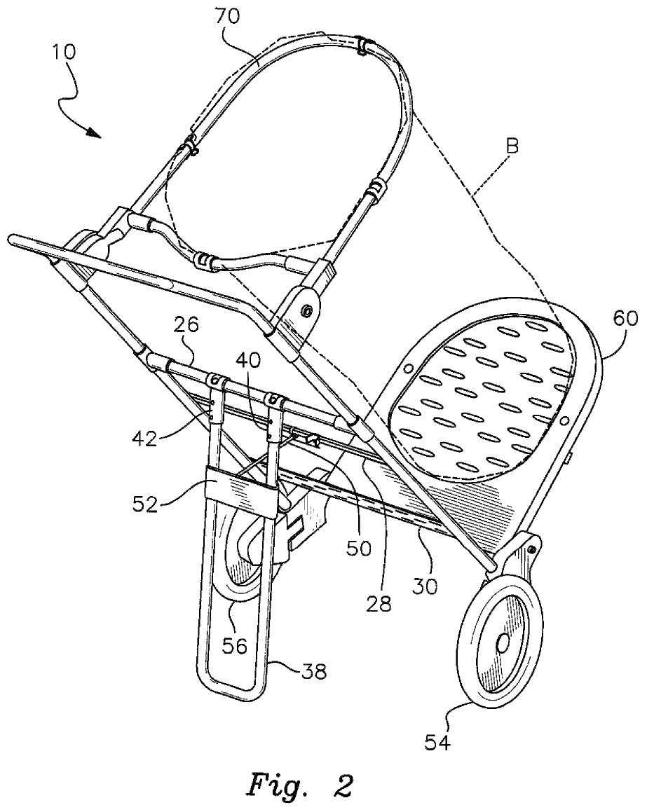

A generally U-shaped support leg 38, which again may comprise a piece of tubular aluminum or other material, is pivotally connected to lateral tube 26. In particular, respective ends of tubular leg 38 are received in corresponding sockets of tubular T-connectors 40 and 42. Support leg 38 is suspended from T-connectors 40 and 42 such that the leg hangs rearwardly of lateral bar 28 and lateral bracket 30. Tube 26 is received through aligned horizontal tubular channels of connectors 40 and 46 such that leg 38 is pivotally mounted to and suspended from tube 26. This allows leg 38 to pivot between the closed condition shown in FIG. 1 and the open condition shown in FIG. 2. As is described more fully below, when the leg 38 is adjusted into the open condition, the cart 10 may be tilted about its wheels to facilitate loading material into a bag supported on the cart.

Lateral bar 28 carries a leg-retaining spring clip 48 that includes a recess configured to generally conform to the cross sectional shape of tubular support leg 38. When the leg is pivoted into the closed condition as shown in FIG. 1, it is snapped into and retained by spring clip 48. Bar 28 also supports a preferably metallic leg-guiding rail 50 that is pivotally attached to bar 28. Rail 50 alternates between the vertical position shown in FIG. 1 when leg 38 is closed, and the extended condition shown in FIG. 2 when the leg is open. More specifically, leg 38 supports a transverse bracket 52 having in its lower edge a slot that is interengaged by guide rail 50. As leg 38 is pivoted open, rail 50 slides through the slot in bracket 52 until a stop carried by the rail blocks further movement of bracket 52 along rail 50. The guide rail thereby limits the degree or angle to which support leg 38 may be pivoted open. Alternative known structure may be employed to adjust or limit the angle which support leg 38 may be pivoted rearwardly of frame 12.

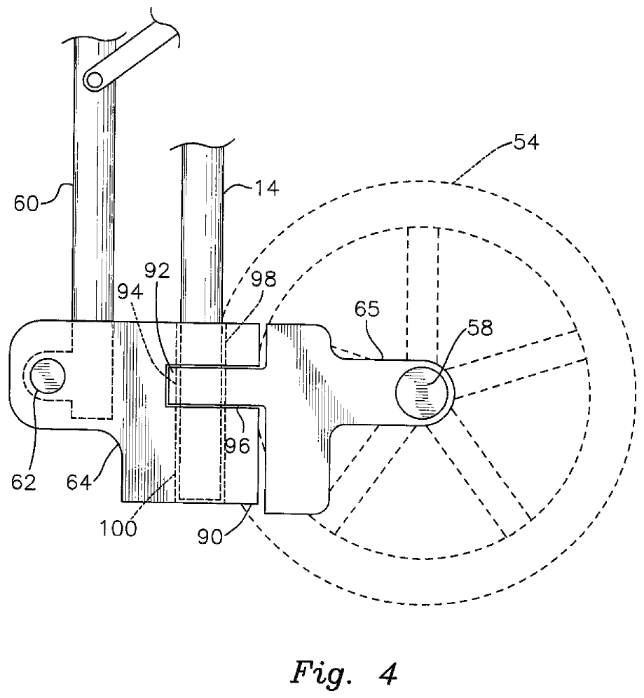

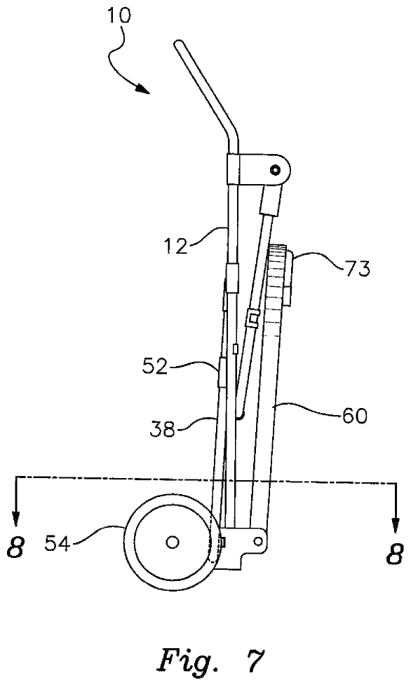

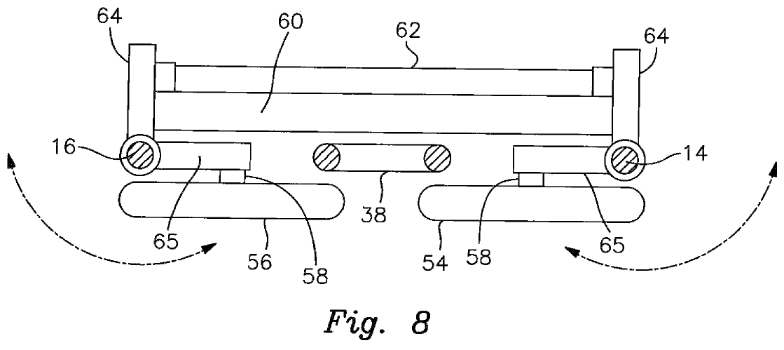

A pair of wheels 54 and 56 are axially rotatably mounted to the lower ends of frame components 14 and 16 respectively. The wheels may be composed of various durable synthetic or natural materials suited for outdoor use in all types of environments. As is described more fully below in connection with FIG. 4, each wheel 54, 56 is pivotally interconnected the frame such that the wheels are alternatable between an open condition, as shown in FIGS. 1-3, and a folded, closed condition, as depicted in FIGS. 7 and 8.

A lower support element 60 comprising a platform is pivotally connected to frame 12 proximate the lower end of the frame. Platform 60 is selectively pivotable between an open condition, shown in FIGS. 1-3, wherein the platform extends forwardly of the frame for supporting bagged yard waste and other items, and a closed or collapsed condition folded against frame 12, as shown in FIGS. 7 and 8.

Wheels 54 and 56 and platform 60 are interconnected to frame 12 in the manner best shown in FIG. 4. It should be understood that a representative wheel 54 and frame component 14, as well as a representative side of platform 60, are depicted therein. An analogous construction is likewise preferably employed for the opposite wheel 56, frame component 16 and associated side of the platform. Platform 60 is pivotally mounted on a shaft 62 that extends between a pair of spaced apart lower support brackets 64 located on respective sides of the cart. A hub 58 of each wheel 54, 56 is axially rotatably mounted to a respective wheel mounting bracket 65. Typically, the hub 58 of each wheel 54, 56 is mounted on an axle that rotatably interengages a complementary bearing mounted within respective bracket 65 or is otherwise constructed to axially rotate in a known manner, not shown. Wheel 54 and a corresponding side of platform 60 are interconnected to respective vertical frame component 14 by a hinge assembly 90 that includes platform-supporting bracket 64 and interengaged wheel bracket 65. In particular, bracket 65 includes a bushing 92 having a vertical channel 94 formed therethrough. Platform supportive bracket 64 includes a slot 96 that receives bushing 92 of bracket 65. Bracket 64 further includes a pair of vertically aligned holes 98 and 100 that correspond with channel 94 in bushing 92. The aligned holes 98, 100 and channel 94 accommodate the lower end of tubular frame component 14 to hingedly join wheel bracket 65 and associated wheel 54 to tubular frame component 14. Again, opposite wheel 56 and the opposite side of platform 60 are foldably connected to opposite frame component 16 in a similar manner. This allows each wheel to be selectively alternated between the open condition shown in FIGS. 1-4 and the collapsed condition, shown in FIGS. 7 and 8. When opened, the wheels are oriented to enable the frame and the cart to roll forwardly and rearwardly. In the collapsed condition, the wheels are oriented to enable the collapsed cart to roll in a selected lateral or sideways direction. In the open condition, the wheels are oriented to be substantially axially aligned with one another and the rotational axis of each wheel extends laterally of the cart. In the closed or collapsed condition the wheels are oriented, to be substantially axially parallel to one another and the rotational axes of the wheels extend forwardly and rearwardly of the frame. The lower hinges may include various types of locking mechanisms to selectively maintain the wheels in either an open or closed condition.

As further shown in FIGS. 1 and 4, respective sides of platform 60 may also be interconnected to tubular components 14, 16 of frame 12 by a pair of lockable folding hinges 63. These hinges typically employ known structure that securely maintains the platform in an open condition when it has been unfolded for use. Magnets 61 may be carried by the upper surface of platform 67 and complementary magnetically attracted components 65 may be supported on lateral bar 28 to adhere to magnets 61 and retain platform 60 securely in the collapsed condition when the cart is not in use.

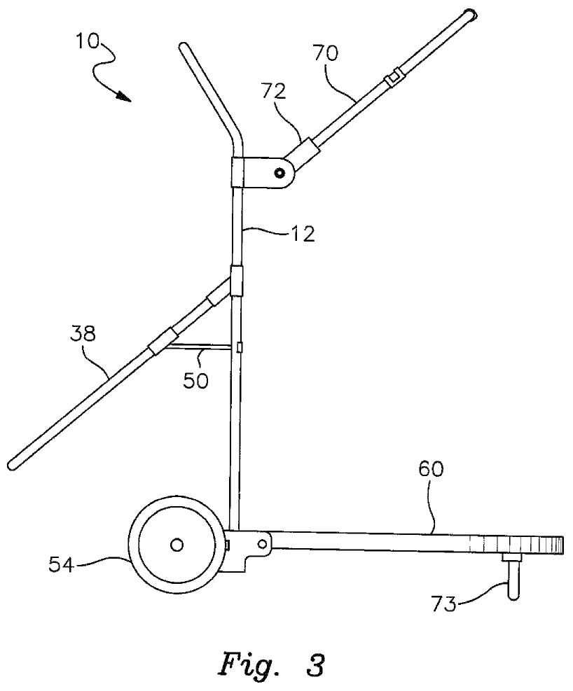

As further shown in FIGS. 1-3 and 7 a supportive platform stand 73 is foldably mounted to the bottom surface of platform 60. When cart stand 73 preferably comprises a tubular metal such as aluminum analogous to the other tubular components employed in the cart. When the cart is in use, stand 73 is deployed by pivoting it open relative to platform 60. As shown in FIGS. 1 and 3, the stand engages the ground or underlying surface to hold the cart securely in place and to bear the weight of the refuse or other items placed on the stand. Various known types of releasable locking devices may be used to hold the stand in a folded condition against the bottom of platform 60.

Cart 10 further includes an upper support element 70 comprising a mounting ring, as best shown in FIGS. 1-3. Mounting ring 70 again employs tubular sections composed of aluminum or another durable, yet lightweight metal or metal alloy. The mounting ring is connected to tubular frame components 14 and 16 by a pair of indexing or ratchet hinges 72 and 74, The hinges include tubular receptacles for interconnecting tubular sections of ring 70 in a closed, end to end manner. Each hinge 72, 74 further includes an indexing or ratchet construction that allows the mounting ring to be pivoted between and locked into preselected angular positions relative to frame 12. Various types of indexing or ratchet hinges understood by persons skilled in the art may be employed. In particular, the preselected positions should include the loading modes shown in FIGS. 1 and 2, wherein the ring is supported to extend forwardly and substantially perpendicularly from frame 12, the angularly elevated bag removal mode shown in FIG. 3 and the collapsed mode shown in FIGS. 7 and 8. Cart 10 functions in these respective conditions or modes in the manner described below. Various forms of releasable locking mechanisms, not shown, may be used to hold mounting ring 70 in its selected position.

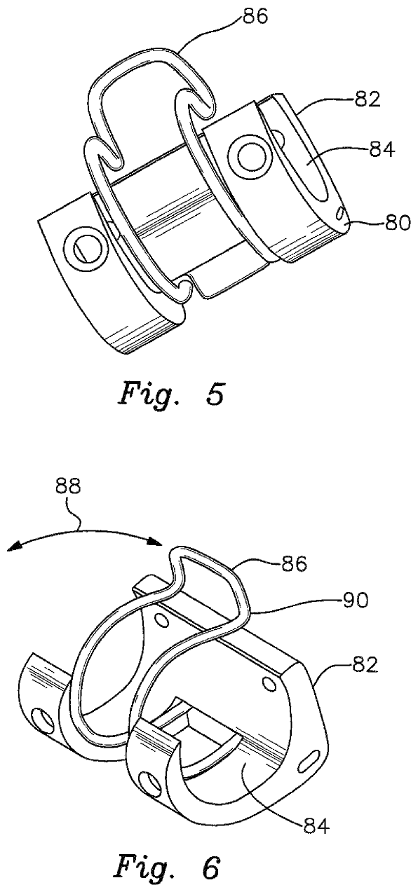

Mounting ring 70 carries a plurality of bag attachment clips 80, which are depicted alone in FIGS. 5 and 6. Each clip includes a semi-cylindrical body 82 having a central channel 84 that conformably receives and interengages mounting ring 70. Each clip 80 may be attached to the mounting ring by screws or other appropriate fasteners. A spring-loaded wire clamp 86 is pivotally secured at respective ends to body 82 and wraps over the open channel and against the outer surface of body 82. As indicated by double-headed arrow 88, FIG. 6, clip 82 may be selectively opened by disengaging bent portion 90 of clamp 86 from clip body 82 and pivoting clamp 86 open relative to body 82. Alternatively, clip 80 is closed to secure a bag wrapped over the mounting ring by pivotally closing wire clamp 86 against clip body 82 and engaging the bent portion 90 of the clamp with the outer surface of the clip body. This allows a refuse collection bag to be selectively attached to or removed from the mounting ring, as required, in a reliable, quick and convenient fashion.

In operation, cart 10 is opened and deployed for use as shown in FIGS. 1-3. To place cart 10 in an upright, bag-loading mode, upper mounting ring 70 is indexed into the forwardly facing horizontal position shown in FIG. 1 and a bag B is attached thereto by opening clips 80, inserting the upper edges of the bag into the clips and then closing clamps 87 of clips 80 to hold the bag in place and in an open condition. Platform 60 is likewise pivoted open and locked securely in place by folding hinges 63. As yard waste or other refuse is collected, it is deposited through the upper mounting ring and into the attached open bag. Support stand 73 is opened to engage the ground and further support platform 60 and the collected debris.

If desired, the cart can be tilted and the bag effectively lowered as shown in FIG. 2. In this mode, the bag is easier to fill because the opening of the bag is supported at a lower height more accessible to most users. Support leg 38 is disengaged from its retaining clip 48 and slid open until the stop on guide rail 50 engages bracket 52. Leg 38 is held in its open position and cart 10 is tilted about wheels 54 and 56 to engage the ground or other underlying surface. Cart 10 is thereby securely supported in the lowered and tilted mode to facilitate refuse collection.

When bag B is filled and needs to be removed, such removal and disposal of the filled bag are facilitated by transitioning the cart into the bag removal mode shown in FIG. 3. Mounting ring 70 is raised into the indexed inclined position, wherein index hinges 72, 74 maintain that position. Clips 80 are then opened by releasing the spring-loaded clamps in the previously described manner. The bag is then disengaged and removed easily from the mounting ring and the cart without interference from platform 60.

Cart 10 may be conveniently moved by tilting the handle of frame 12 rearwardly and pushing the cart to roll over grass or other underlying surfaces. This operation can be performed while an attached collection bag remains on the cart so that the bag can be delivered to a desired destination for disposal. Alternatively, cart 10 can be used to carry other items such as fertilizer, pesticides, pavers or other yard/landscape supplies without requiring the use of the upper mounting ring. In such cases, the user simply pivots the mounting ring downwardly into the indexed collapsed condition shown in FIGS. 7 and 8. The lower platform and wheels remain deployed, which enables a wide variety of items to be transported quickly, conveniently and with less risk of back strain or other injury.

When not in use, cart 10 is easily and very compactly collapsible for storage, transport and travel. Both the upper mounting ring 70 and lower mounting support platform 60 are folded closed in the previously described manner such that they essentially lay flat or flush against the frame 12. See FIGS. 7 and 8. Wheels 54 and 56 may be left open as depicted in FIG. 7. Alternatively, as shown in FIG. 8, the wheels can also be collapsed in the manner previously described. In this condition, the cart is extremely compact and can fit easily in even extremely restricted spaces. Moreover, when the wheels are folded, the cart can be conveniently rolled sideways along the ground or underlying surface, even in the fully collapsed condition. This makes transporting the collapsed cart even easier and is an advantageous feature unavailable in utility carts of the prior art.

It should be understood that the hinges, brackets, T-connectors, clips, platform and other components described above may be composed of various types of plastic and other synthetics, as well as metals and metal alloys. Strong, durable and lightweight materials are especially preferred. The particular composition or configuration of the individual components is nota limitation of this invention.

Accordingly, this invention offers an improved and highly efficient and ergonomic utility cart that can be used advantageously in a variety of modes. The cart is more versatile and compactly collapsible than known carts. While this detailed description has set forth particularly preferred embodiments of the apparatus of this invention, numerous modifications and variations of the structure of this invention, all within the scope of this invention, will readily occur to those skilled in the art. Accordingly, it is understood that this description is illustrative only of the principles of the invention and is not limitative thereof.

Although specific features of the invention are shown in some of the drawings and not others, this is for convenience only, as each feature may be combined with any and all of the other features in accordance with this invention.

Other embodiments will occur to those skilled in the art an dare within the following claims.

What is claimed is:

1. A collapsible utility cart comprising:
an elongate frame having upper and lower ends;
a handle formed proximate said upper end of said frame;
a pair of wheels axially rotatably connected to said frame proximate said lower end of said frame, each said wheel including a hub that is pivotally interconnected to said frame such that said wheels are selectively alternatable between an open condition wherein said wheels are substantially axially aligned with one another and a folded condition wherein said wheels are substantially axially parallel to one another; a lower support element interconnected pivotally to said frame proximate a lower end of said frame; an upper support element interconnected pivotally to said frame proximate an upper end of said frame;
said lower support element being pivotally alternatable between a collapsed condition wherein said lower support element is folded against said frame and an open condition wherein said lower support element extends in a forward direction from said frame; said upper support element being pivotally alternatable between a collapsed condition wherein said upper support element is folded against said frame and an open condition wherein said upper support element extends in said forward direction from said frame; said upper support element carrying one or more clips for selectively attaching to a collection bag to secure the collection bag to said upper support element; said frame carrying a supportive leg for engaging the ground or other underlying surface when said frame is inclined about said wheels with said wheels in said open condition to support said frame at an angle to the underlying surface.

2. The apparatus of claim 1 in which said frame includes a spaced apart, substantially parallel pair of vertical tubular frame components interconnected at respective upper ends of said frame components by a handle.

3. The apparatus of claim 2 in which each said hub is connected to a respective wheel mounting bracket, which wheel mounting bracket is hingedly joined to a respective tubular frame component.

4. The apparatus of claim 3 in which said lower support element includes a platform that is pivotally mounted between a pair of lower support mounting brackets, said brackets being connected to respective said tubular frame components proximate lower ends thereof.

5. The apparatus of claim 4 in which said platform is interconnected to said frame by a pair of lockable folding hinge elements, each said lockable folding hinge element interconnecting a respective side of said lower support element with one side of said platform with an intermediate segment of a respective vertical frame component between said upper and said lower ends of said frame.

6. The apparatus of claim 4 further including a platform support stand attached to a bottom of said platform for engaging the ground or other underlying surface when said platform is opened.

7. The apparatus of claim 6 in which said platform support stand is foldably connected to said platform such that said support stand may be folded closed against said bottom of said platform when said platform is in a closed condition.

8. The apparatus of claim 1 in which said upper support element includes a mounting ring pivotally attached by a pair of upper support mounting brackets to respective said vertical frame components proximate said upper end of said frame.

9. The apparatus of claim 1 in which said support leg is pivotally connected to a portion of said frame extending between said tubular vertical frame components for alternating between a closed condition wherein said support leg is folded against said frame and an open condition wherein said support leg extends at a positive angle relative to said frame.

10. The apparatus of claim 3 in which each said wheel mounting bracket is hingedly interengaged with a respective lower support mounting bracket.

11. The apparatus of claim 10 in which each said wheel mounting bracket includes a bushing having a vertical channel formed therethrough, said lower support mounting bracket including a slot that receives said bushing and a pair of vertically aligned holes that align with said channel of said bushing received in said slot, said aligned holes and said bushing accommodating a respective vertical frame component such that said wheel mounting bracket is pivotally interengaged with said respective lower support mounting component and hingedly joined to a respective said tubular frame component.

12. The apparatus of claim 8 in which said upper ring is pivotal upwardly beyond said open condition such that said upper ring extends at an angle greater than ninety degrees to said frame for permitting a bag attached to said clips to be disengaged from said clips and conveniently removed from said cart without interference from said upper support ring.

13. The apparatus of claim 8 in which each upper support mounting bracket includes an indexing hinge that allows said mounting ring to be pivotally adjusted and held in a selected pivotal position relative to said frame.
